(19) United States
(12) Patent Application Publication
(10) Pub. No.: US 2025/0125887 A1
(43) Pub. Date: Apr. 17, 2025

(54) Apparatus and Method for Testing Connected Vehicle's Communication Distance

(71) Applicant: CATARC Automotive Test Center (Tianjin) Co., Ltd., Tianjin (CN)

(72) Inventors: Xiaodi TIAN, Tianjin (CN); Guokai JIANG, Tianjin (CN); Bowei ZOU, Tianjin (CN); Feiyan WU, Tianjin (CN); Xin LI, Tianjin (CN); Xuebin SHAO, Tianjin (CN); Fujian HE, Tianjin (CN); Chun LI, Tianjin (CN); Rupeng DOU, Tianjin (CN); Jiaxu FENG, Tianjin (CN); Zhiqiang YANG, Tianjin (CN); Shasha TANG, Tianjin (CN); Xiucheng LI, Tianjin (CN); Xiaolong ZHAO, Tianjin (CN); Dandan WU, Tianjin (CN); Jinna FAN, Tianjin (CN); Quan WEN, Tianjin (CN); Ji HUANG, Tianjin (CN); Jiaoyang LIU, Tianjin (CN); Yu WANG, Tianjin (CN); Mengdan WANG, Tianjin (CN)

(21) Appl. No.: 18/916,523

(22) Filed: Oct. 15, 2024

(30) Foreign Application Priority Data
Oct. 17, 2023 (CN) 202311336647.7

(51) Int. Cl. H04B 17/10; H04B 17/20; H04L 43/0829

(52) U.S. Cl. CPC H04B 17/102; H04B 17/202; H04L 43/0829

(57) ABSTRACT

This application relates to the technical field of connectivity communication, and provides an apparatus and method for testing a connected vehicle's communication distance. The testing apparatus includes a support member, and a first antenna is provided on the support member and connected to a signal transceiver. The signal transceiver is configured to send signals to a tested vehicle or receive signals sent by the tested vehicle. An output terminal of the signal transceiver is connected to an upper computer. Data analysis software is installed on the upper computer, and used for recording a test distance and a number of data packets and calculating a packet loss rate, such that a maximum communication distance is obtained according to the test distance and the corresponding packet loss rate.

### CROSS REFERENCE TO RELATED APPLICATION

This patent application claims the benefit and priority of Chinese Patent Application No. 202311336647.7, filed with the China National Intellectual Property Administration on Oct. 17, 2023, the disclosure of which is incorporated by reference herein in its entirety as part of the present application.

### TECHNICAL FIELD

The present disclosure relates to the technical field of vehicle connectivity communication, and specifically, to an apparatus and method for testing a connected vehicle's communication distance.

### BACKGROUND

Intelligent and connected vehicles have become the strategic development direction for future vehicles. Intelligent and connected vehicles involve two primary technical approaches: intelligence and vehicle connectivity. While intelligent technologies face challenges such as susceptibility to external weather conditions, complex algorithms, limited perception range, and high costs, vehicle connectivity technologies can help address these issues. The application of connectivity functions involves using the vehicle as a carrier to exchange information with external entities such as pedestrians, other vehicles, roads, and platforms via antennas. By leveraging connectivity communication, safety applications can be implemented to effectively avoid and reduce collision accidents. Consequently, an effective communication distance becomes a fundamental requirement for realizing safety applications. However, connectivity communication can be easily affected by external environments and varying scenarios, making it crucial to objectively verify connected vehicle's communication distances across different scenarios.

Currently, there are two main methods for testing communication distance. The first method involves translating the communication distance into vehicle antenna gain, transmitting power, and receiving sensitivity based on wireless communication theory. The communication distance can be tested and evaluated through component conduction and vehicle antenna performance tests in the anechoic chamber, though this approach does not account for real-world environmental influences. The second method tests the communication distance of the tested vehicle in real-world conditions, using a target vehicle equipped with connectivity communication capabilities. The target vehicle can broadcast or receive information through antennas. However, because vehicle antenna performance tests are demanding in test sites, time-consuming, and costly, and because the antenna performance of the target vehicle is often unknown with limited resources, it is challenging to ensure that the target vehicle remains consistent for each test. Both existing testing methods have limitations and do not fully meet the needs for objective and reproducible testing of connected vehicle's communication distances in real-world environments.

### SUMMARY

In view of the above-mentioned defects or deficiencies in the prior art, it is desirable to provide an apparatus and method for testing a connected vehicle's communication distance, to resolve the above-mentioned technical problems.

A first aspect of the present disclosure provides an apparatus for testing a connected vehicle's communication distance, including:
a support member;
a first antenna arranged on the support member;
a signal transceiver, where the signal transceiver is connected to the first antenna and is configured to send signals to a tested vehicle and/or receive signals sent by the tested vehicle;
an upper computer, where the upper computer is connected to an output terminal of the signal transceiver, data analysis software is installed on the upper computer, and the data analysis software is used for recording a test distance and a number of data packets and calculating a packet loss rate.

According to the technical solutions provided in the present disclosure, an iron plate is arranged at the top of the support member, and the first antenna is arranged at the top of the iron plate, and the iron plate is used for simulating a vehicle shell.

According to the technical solutions provided in the present disclosure, the support member is a foam bracket, and the foam bracket does not reflect or attenuate the signals sent and/or received by the signal transceiver.

A second aspect of the present disclosure provides a method for testing a connected vehicle's communication distance, adopting the apparatus for testing a connected vehicle's communication distance according to the first aspect, and including the following steps:
S100: selecting a test scene, and selecting a test site according to the test scene;
S200: according to the test scene, placing the testing apparatus in the test site, powering on the testing apparatus, and verifying that the testing apparatus works normally;
S300: placing a tested vehicle in the test site;
S400: performing interconnection debugging between the tested vehicle and the testing apparatus; and
S500: testing a maximum communication distance of the tested vehicle in receiving and/or sending modes in the test scene.

According to the technical solutions provided in the present disclosure, before the step S100, performance of the testing apparatus is tested to confirm that a test result of the testing apparatus meets a communication requirement, and the test result includes an antenna gain of the first antenna, and transmitting power and receiving sensitivity of the signal transceiver; specifically, the following steps are included:
S1: placing the testing apparatus on a turntable in a shielded chamber, and enabling a center of the testing apparatus to coincide with a center of the turntable;
S2: providing a test antenna at the top of the shielded chamber, and moving the test antenna in a circular motion centered on a center of the support member, to form a ¼ arc-shaped track;
S3: disconnecting the first antenna from the signal transceiver, connecting the first antenna to a second port of a network analyzer, and connecting the test antenna to a first port of the network analyzer;
S4: keeping a vertical angle of the test antenna unchanged, rotating the turntable in a horizontal direction, performing tests at different frequencies within a first angle range, and recording amplitudes and phases of near-field horizontal and vertical polarizations at each angle;
S5: keeping a horizontal angle of the first antenna unchanged, controlling the test antenna to move in a circular motion centered on the center of the support member, performing tests at different frequencies within a second angle range, and recording amplitudes and phases of near-field horizontal and vertical polarizations at each angle;
S6: performing, by using the network analyzer, near-field to far-field transformation on the amplitudes and phases of the near-field horizontal and vertical polarizations, to obtain the antenna gain of the first antenna; and
S7: connecting the signal transceiver to a broadband wireless communication tester, to measure the transmitting power and the receiving sensitivity of the signal transceiver.

According to the technical solutions provided in the present disclosure, the test scene includes a straight road scene, a straight road scene with a block, an intersection scene, and an intersection scene with a block.

According to the technical solutions provided in the present disclosure, if the test scene is the straight road scene, the step S500 includes the following steps:
S501: placing the testing apparatus and the tested vehicle at a first preset distance from each other in the test site, where the test site is a straight road;
S502: receiving or sending, by the tested vehicle, signals, recording a number of data packets corresponding to the first preset distance, and calculating a packet loss rate;
S503: when it is determined that the packet loss rate is 0%, increasing a distance between the testing apparatus and the tested vehicle by 30 meters;
S504: when it is determined that the packet loss rate is greater than 0% and less than 5%, increasing the distance between the testing apparatus and the tested vehicle by 20 meters;
S505: receiving or sending, by the tested vehicle, signals, recording a number of data packets corresponding to a current communication distance, and calculating the corresponding packet loss rate; and
S506: repeating the steps S503 to S505 until the packet loss rate is greater than 5%, and taking the current communication distance between the tested vehicle and the testing apparatus as the maximum communication distance.

According to the technical solutions provided in the present disclosure, if the test scene is the straight road scene with a block, the step S500 includes the following steps:
S511: placing the testing apparatus and the tested vehicle at a second preset distance from each other in the test site, where a first block is disposed between the testing apparatus and the tested vehicle, and the test site is a straight road;
S512: receiving or sending, by the tested vehicle, signals, recording a number of data packets corresponding to the second preset distance, and calculating a packet loss rate;
S513: when it is determined that the packet loss rate is 0%, increasing a distance between the testing apparatus and the tested vehicle by 30 meters;
S514: when it is determined that the packet loss rate is greater than 0% and less than 5%, increasing the distance between the testing apparatus and the tested vehicle by 20 meters;
S515: receiving or sending, by the tested vehicle, signals, recording a number of data packets corresponding to a current communication distance, and calculating the corresponding packet loss rate; and
S516: repeating the steps S513 to S515 until the packet loss rate is greater than 5%, and taking the current communication distance between the tested vehicle and the testing apparatus as the maximum communication distance.

According to the technical solutions provided in the present disclosure, if the test scene is the intersection scene, the step S500 includes the following steps:
S521: placing the testing apparatus and the tested vehicle in the test site, where the test site is a crossroads, and the testing apparatus and the tested vehicle each are disposed at a third preset distance from a center of the crossroads;
S522: receiving or sending, by the tested vehicle, signals, recording a number of data packets corresponding to the third preset distance, and calculating a packet loss rate;
S523: when it is determined that the packet loss rate is 0%, increasing a distance between the testing apparatus and the tested vehicle by greater than 20 meters;
S524: when it is determined that the packet loss rate is greater than 0% and less than 5%, increasing the distance between the testing apparatus and the tested vehicle by 20 meters;
S525: receiving or sending, by the tested vehicle, signals, recording a number of data packets corresponding to a current communication distance, and calculating the corresponding packet loss rate; and
S526: repeating the steps S523 to S525 until the packet loss rate is greater than 5%, and taking the current communication distance between the tested vehicle and the testing apparatus as the maximum communication distance.

According to the technical solutions provided in the present disclosure, if the test scene is the intersection scene with a block, the step S500 includes the following steps:
S531: placing the testing apparatus and the tested vehicle in the test site, where the test site is a crossroads, the testing apparatus and the tested vehicle each are disposed at a fourth preset distance from a center of the crossroads, and a second block is disposed at a side, of the tested vehicle, close to the testing apparatus;
S532: receiving or sending, by the tested vehicle, signals, recording a number of data packets corresponding to the fourth preset distance, and calculating a packet loss rate;
S533: when it is determined that the packet loss rate is 0%, increasing a distance between the testing apparatus and the tested vehicle by greater than 20 meters;
S534: when it is determined that the packet loss rate is greater than 0% and less than 5%, increasing the distance between the testing apparatus and the tested vehicle by 20 meters;
S535: receiving or sending, by the tested vehicle, signals, recording a number of data packets corresponding to a current communication distance, and calculating the corresponding packet loss rate; and
S536: repeating the steps S533 to S535 until the packet loss rate is greater than 5%, and taking the current communication distance between the tested vehicle and the testing apparatus as the maximum communication distance.

The present disclosure has the following beneficial effects:

The present disclosure provides an apparatus and method for testing a connected vehicle's communication distance. The testing apparatus includes a support member, and a first antenna is provided on the support member and connected to a signal transceiver. The signal transceiver is configured to send signals to a tested vehicle or receive signals sent by the tested vehicle. An output terminal of the signal transceiver is connected to an upper computer. Data analysis software is installed on the upper computer, and used for recording a test distance and a number of data packets and calculating a packet loss rate, such that a maximum communication distance is obtained according to the test distance and the corresponding packet loss rate. The testing apparatus is connected to the tested vehicle to replace the target vehicle in the prior art. Compared with the target vehicle, the testing apparatus is small, which results in lower requirements for the antenna performance test site, reduced test costs, and higher test efficiency. Additionally, the testing apparatus is fixed during each test, allowing for objective and repeatable measurements of the connected vehicle's communication distance of the tested vehicle in a real-world environment.

### BRIEF DESCRIPTION OF THE DRAWINGS

Other features, objectives, and advantages of the present disclosure will become more apparent by reading the detailed description of non-limiting embodiments with reference to the following accompanying drawings.

FIG. 1 is a schematic diagram of an apparatus for testing a connected vehicle's communication distance according to an the present disclosure;

FIG. 2 is a schematic diagram of performance testing of a first antenna;

FIG. 3 is a schematic diagram of the front of a tested vehicle and a testing apparatus when a test scene is a straight road scene;

FIG. 4 is a schematic diagram of the rear of a tested vehicle and a testing apparatus when a test scene is a straight road scene;

FIG. 5 is a schematic diagram of the front of a tested vehicle and a testing apparatus when a test scene is a straight road scene with a block;

FIG. 6 is a schematic diagram of the rear of a tested vehicle and a testing apparatus when a test scene is a straight road scene with a block;

FIG. 7 is a schematic diagram of the front of a tested vehicle and a testing apparatus when a test scene is an intersection scene;

FIG. 8 is a schematic diagram of the tail of a tested vehicle and a testing apparatus when a test scene is an intersection scene;

FIG. 9 is a schematic diagram of the front of a tested vehicle and a testing apparatus when a test scene is an intersection scene with a block;

FIG. 10 is a schematic diagram of the front of a tested vehicle and a testing apparatus when a test scene is an intersection scene with a block;

FIG. 11 is a flow chart of a method for testing a connected vehicle's communication distance.

Reference numerals: 1: support member; 2: iron plate; 3: first antenna; 4: signal transceiver; 5: upper computer; 6: test antenna; 7: network analyzer; 8: turntable; 9: shielded chamber; 10: tested vehicle; 11: first block; 12: second block.

### DETAILED DESCRIPTION OF THE EMBODIMENTS

The present disclosure is further described in detail below with reference to the accompanying drawings and embodiments. It may be understood that the specific embodiments described herein are merely intended to explain the related invention, rather than to limit the present disclosure. In addition, it should also be noted that, for ease of description, only parts related to the present disclosure are shown in the accompanying drawings.

It should be noted that the examples in the present disclosure or features in the examples may be combined in a non-conflicting manner. The present disclosure will be described in detail below with reference to the accompanying drawings and the embodiments.

### Embodiment 1

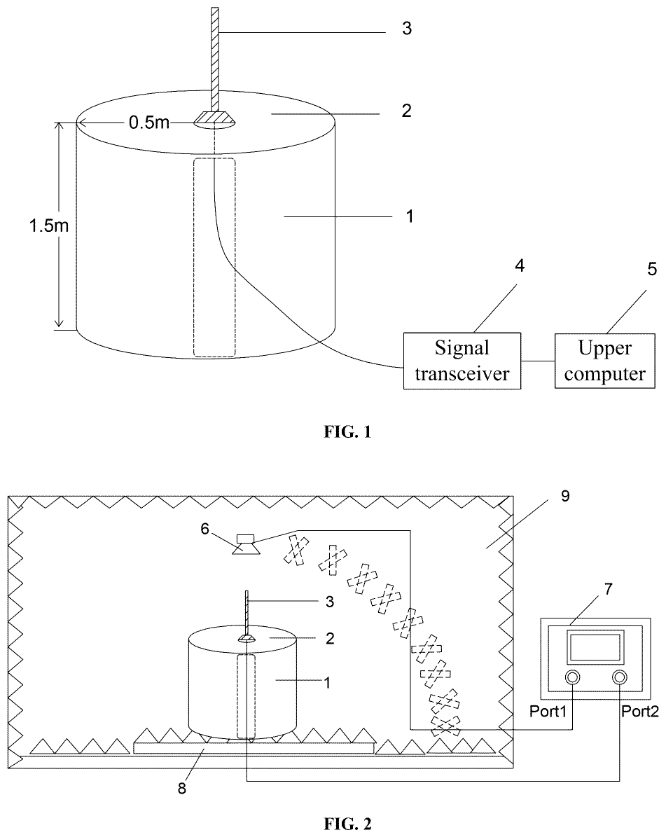

Referring to FIG. 1, the present disclosure provides an apparatus for testing a connected vehicle's communication distance, including:
a support member 1;
a first antenna 3 arranged on the support member 1;
a signal transceiver 4, where the signal transceiver 4 is connected to the first antenna 3 and is configured to send signals to a tested vehicle 10 and/or receive signals sent by the tested vehicle 10;
an upper computer 5, where the upper computer 5 is connected to an output terminal of the signal transceiver 4, data analysis software is installed on the upper computer 5, and the data analysis software is used for recording a test distance and a number of data packets and calculating a packet loss rate.

Specifically, as shown in FIG. 1, the testing apparatus includes the support member 1, the first antenna 3, the signal transceiver 4, and the upper computer 5. The first antenna 3 is arranged on the support member 1. In this embodiment, the first antenna 3 is an omni-directional antenna (Typically, a vehicle-mounted antenna is affected by the vehicle metal structure, which can degrade the roundness of the directional pattern. This results in varying transmission or reception performance at different angles. Additionally, the angles between the testing apparatus and the tested vehicle 10 vary in different test scenes, making it challenging for standard antennas to consistently achieve objective test indicators. Therefore, an omni-directional antenna is chosen for the first antenna 3, to ensure consistent performance in all directions and allows for reproducible tests). The first antenna 3 is connected to the signal transceiver 4, and the signal transceiver 4 can send signals to and/or receive signals from the tested vehicle 10. An output terminal of the signal transceiver 4 is connected to the upper computer 5, and the data analysis software is installed on the upper computer 5. The data analysis software is used for recording the test distance and the number of data packets and calculating the packet loss rate.

When testing, indicators of the connected vehicle's communication distance can be easily influenced by different roads and environments. Before each formal test, the test scene needs to be confirmed, and the test site is selected according to the test scene. The testing apparatus is placed in the test site according to the test scene. The testing apparatus is powered on to verify that the testing apparatus works normally. Then, the tested vehicle 10 is placed in the test site, and interconnection debugging is performed between the tested vehicle 10 and the testing apparatus. After debugging, when a stable communication connection is ensured between the tested vehicle 10 and the testing apparatus, the tested vehicle 10 receives signals sent by the testing apparatus and sends signals to the testing apparatus in the test scene. The data analysis software records the test distance and the number of data packets, and calculates the packet loss rate, such that the maximum communication distance of the tested vehicle 10 in receiving and/or sending modes is determined.

Working principle: The testing apparatus is connected to the tested vehicle 10, to replace the target vehicle used in prior art. Compared with the target vehicle, the testing apparatus is small, which results in lower requirements for the antenna performance test site, reduced test costs, and higher test efficiency. Additionally, the testing apparatus is fixed during each test, allowing for objective and repeatable measurements of the connected vehicle's communication distance of the tested vehicle 10 in a real-world environment.

In some implementations, an iron plate 2 is arranged at the top of the support member 1, the first antenna 3 is arranged at the top of the iron plate 2, and the iron plate 2 is used for simulating a vehicle shell.

Specifically, the top of the support member 1 is provided with the iron plate 2, and the top of the iron plate 2 is provided with the first antenna 3. In this embodiment, the iron plate 2 is an iron disc with a diameter of 1 m. Since vehicle shells are typically made of iron, this material can impact indicators of the antenna performance. In order to simulate the antenna performance of the vehicle more truly, the apparatus simulates the antenna placement above the real vehicle body by fixing the antenna at the center of the iron plate 2. A small through hole is provided at the center of the iron plate 2 to allow a wire harness to pass through, such that the wire harness of the antenna is connected to the signal transceiver beneath the iron plate.

In some embodiments, the support member 1 is a foam bracket, and the foam bracket does not reflect or attenuate the signals sent and/or received by the signal transceiver 4.

Specifically, the support member 1 is a foam bracket, and the foam bracket is used to support the iron plate 2 and the first antenna 3. Made of foam material, the support member 1 does not reflect or attenuate the signals sent and received by the signal transceiver 4 and has no impact on the test performance of the testing apparatus. In this embodiment, to mimic the height of an antenna on the roof of a conventional passenger car, the height of the foam bracket is set to 1.5 meters.

### Embodiment 2

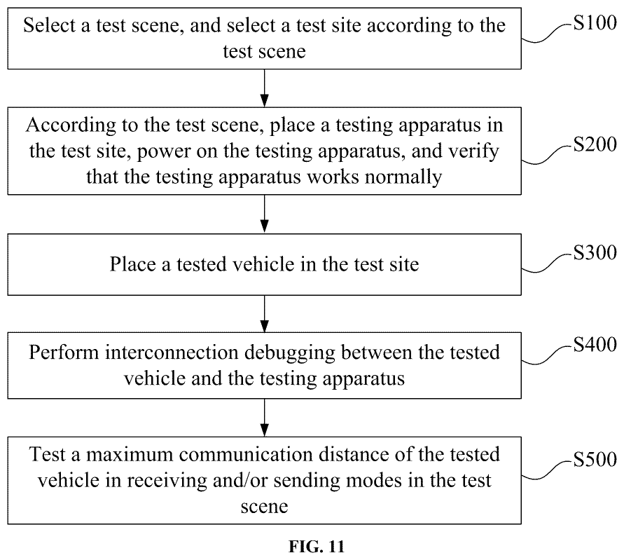

FIG. 11 is a flow chart of a method for testing a connected vehicle's communication distance according to the present disclosure, including the following steps:
S100: Select a test scene, and select a test site according to the test scene.
S200: According to the test scene, place the testing apparatus in the test site, power on the testing apparatus, and verify that the testing apparatus works normally.
S300: Place a tested vehicle in the test site.
S400: Perform interconnection debugging between the tested vehicle and the testing apparatus.
S500: Test a maximum communication distance of the tested vehicle in receiving and/or sending modes in the test scene.

Specifically, the testing apparatus includes a support member 1, a first antenna 3, a signal transceiver 4, and an upper computer 5. The first antenna 3 is arranged on the support member 1. In this embodiment, the first antenna 3 is an omni-directional antenna (Typically, a vehicle-mounted antenna is affected by the vehicle metal structure, which can degrade the roundness of the directional pattern. This results in varying transmission or reception performance at different angles. Additionally, the angles between the testing apparatus and the tested vehicle 10 vary in different test scenes, making it challenging for standard antennas to consistently achieve objective test indicators. Therefore, an omni-directional antenna is chosen for the first antenna 3, to ensure consistent performance in all directions and allows for reproducible tests). The first antenna 3 is connected to the signal transceiver 4, the signal transceiver 4 can send signals to and/or receive signals from the tested vehicle 10. An output terminal of the signal transceiver 4 is connected to the upper computer 5, and the data analysis software is installed on the upper computer 5. The data analysis software is used for recording the test distance and the number of data packets and calculating the packet loss rate.

When testing, indicators of the connected vehicle's communication distance can be easily influenced by different roads and environments. Before each formal test, the test scene needs to be confirmed, and the test site is selected according to the test scene. The testing apparatus is placed in the site according to the test scene. The testing apparatus is powered on to verify that the testing apparatus works normally. Then, the tested vehicle 10 is placed in the test site, and interconnection debugging is performed between the tested vehicle 10 and the testing apparatus. After debugging, when a stable communication connection is ensured between the tested vehicle 10 and the testing apparatus, the tested vehicle 10 receives signals sent by the testing apparatus and sends signals to the testing apparatus in the test scene. The data analysis software records the test distance and the number of data packets, and calculates the packet loss rate, such that the maximum communication distance of the tested vehicle 10 in receiving and sending modes is determined.

The testing apparatus is connected to the tested vehicle 10, to replace the target vehicle used in prior art. Compared with the target vehicle, the testing apparatus is small, which results in lower requirements for the antenna performance test site, reduced test costs, and higher test efficiency. Additionally, the testing apparatus is fixed during each test, allowing for objective and repeatable measurements of the connected vehicle's communication distance of the tested vehicle 10 in a real-world environment.

In some implementations, before the step S100, performance of the testing apparatus is tested to confirm that a test result of the testing apparatus meets a communication requirement, and the test result includes an antenna gain of the first antenna, and transmitting power and receiving sensitivity of the signal transceiver; specifically, the following steps are included:
S1: Place the testing apparatus on a turntable in a shielded chamber, and enable a center of the support member to coincide with a center of the turntable.
S2: Provide a test antenna at the top of the shielded chamber, and move the test antenna in a circular motion centered on a center of the first antenna, to form a ¼ arc-shaped track.
S3: Disconnect the first antenna from the signal transceiver, connect the first antenna to a second port of a network analyzer, and connect the test antenna to a first port of the network analyzer.
S4: Keep a vertical angle of the test antenna unchanged, rotate the turntable in a horizontal direction, perform tests at different frequencies within a first angle range, and record amplitudes and phases of near-field horizontal and vertical polarizations at each angle.
S5: Keep a horizontal angle of the first antenna unchanged, control the test antenna to move in a circular motion centered on the center of the first antenna, perform tests at different frequencies within a second angle range, and record amplitudes and phases of near-field horizontal and vertical polarizations at each angle.
S6: Perform, by using the network analyzer, near-field to far-field transformation on the amplitudes and phases of the near-field horizontal and vertical polarizations, to obtain the antenna gain of the first antenna; and
S7: Connect the signal transceiver to a broadband wireless communication tester, to measure the transmitting power and the receiving sensitivity of the signal transceiver.

Specifically, before connecting the testing apparatus to the tested vehicle for measuring the maximum communication distance of the tested vehicle 10, the performance of the testing apparatus is tested to verify that the test result of the testing apparatus meets the communication requirement. In this embodiment, the communication requirement includes: the antenna gain of the first antenna 3≥−8 dBi, the transmitting power of the signal transceiver 4 is 23±3.3 dBm, and the receiving sensitivity of the signal transceiver 4≤−86.1 dBm. Once the performance test of the testing apparatus is completed, the performance indicators of the testing apparatus are fixed. The testing apparatus can then be repeatedly connected to the tested vehicle 10 for subsequent tests without needing to remeasure the performance of the testing apparatus each time.

Specifically, the performance test of the testing apparatus includes an antenna performance test and a device performance test.

As shown in FIG. 2, when the antenna performance test is performed, the testing apparatus is placed on the turntable 8 in the shielded chamber 9, which is free from electromagnetic wave reflections, ensuring that the center of the support member 1 coincides with the center of the turntable 8. In this embodiment, the first antenna 3 is positioned at the center of the support member 1. The test antenna 6 is provided at the top of the shielded chamber 9 and moves in a circular motion centered on the center of the support member 1, to form a ¼ arc-shaped track. The first antenna 3 is disconnected from the signal transceiver 4 and is connected to a second port of the network analyzer 7, and the test antenna 6 is connected to a first port of the network analyzer 7 (as shown in FIG. 2, Port1 is the first port and Port2 is the second port). Once the apparatus is connected, the test starts. First, a vertical angle of the test antenna 6 keeps unchanged while the turntable 8 is rotated in a horizontal direction. Tests are conducted at different frequencies within a first angle range. In this embodiment, the first angle range is 0° to 360°. The network analyzer 7 records amplitudes and phases of near-field horizontal and vertical polarizations at each angle. Then, a horizontal angle of the first antenna 3 keeps unchanged, that is, the first antenna 3 maintains an initial state, and the test antenna 6 is controlled to move in a circular motion centered on the center of the support member 1. Tests are conducted at different frequencies within a second angle range. In this embodiment, the second angle range is 0° to 96°. The network analyzer 7 records amplitudes and phases of near-field horizontal and vertical polarizations at each angle. The network analyzer 7 performs near-field to far-field transformation on the amplitudes and phases of the near-field horizontal and vertical polarizations, to obtain the antenna gain of the first antenna 3.

Specifically, when the device performance test is performed, the signal transceiver 4 is connected to a broadband wireless communication tester, and the signal transceiver 4 sends and receives signals, to measure the transmitting power and the receiving sensitivity of the signal transceiver 4.

In some implementations, the test scene includes a straight road scene, a straight road scene with a block, an intersection scene, and an intersection scene with a block.

Specifically, indicators of the connected vehicle's communication distance can be easily influenced by different roads and environments. By considering actual road and environmental conditions, the scenes can be categorized into the following classic scenes: a straight road scene, a straight road scene with a block, an intersection scene, and an intersection scene with a block.

In some implementations, if the test scene is the straight road scene, the step S500 includes the following steps:
S501: Place the testing apparatus and the tested vehicle at a first preset distance from each other in the test site, where the test site is a straight road.
S502: The tested vehicle receives or sends signals, a number of data packets corresponding to the first preset distance is recorded, and a packet loss rate is calculated.
S503: When it is determined that the packet loss rate is 0%, increase a distance between the testing apparatus and the tested vehicle by 30 meters.
S504: When it is determined that the packet loss rate is greater than 0% and less than 5%, increase the distance between the testing apparatus and the tested vehicle by 20 meters.
S505: The tested vehicle receives or sends signals, a number of data packets corresponding to a current communication distance is recorded, and the corresponding packet loss rate is calculated.
S506: Repeat the steps S503 to S505 until the packet loss rate is greater than 5%, and take the current communication distance between the tested vehicle and the testing apparatus as the maximum communication distance.

Specifically, testing of the maximum communication distance of the tested vehicle 10 includes testing of the maximum communication distances for the front and the rear of the vehicle.

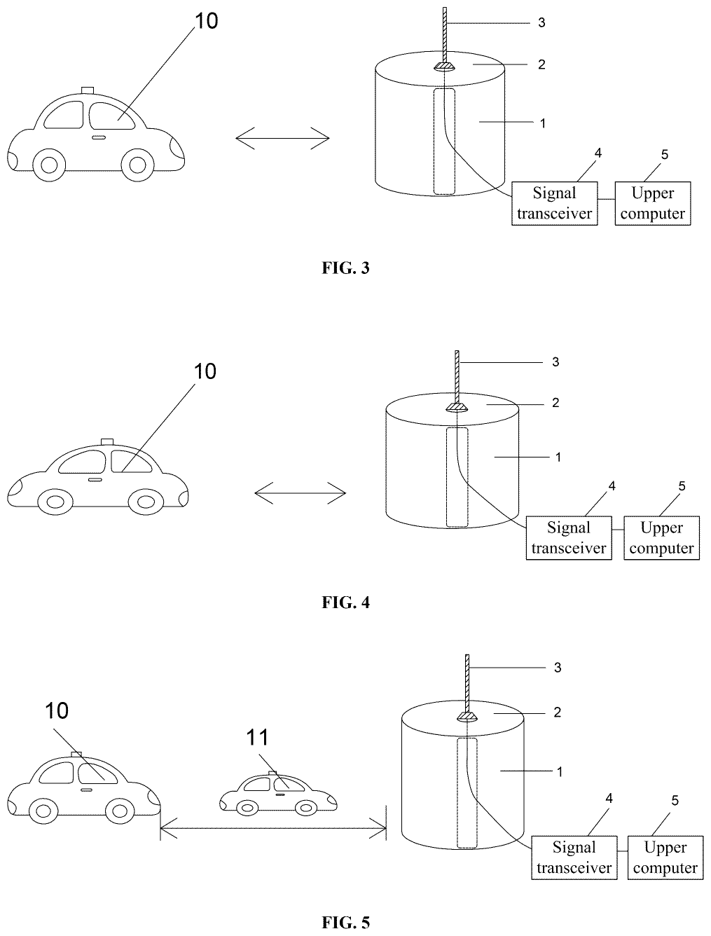

First, the maximum communication distance is tested for the front of the tested vehicle 10. As shown in FIG. 3, when the test scene is a straight road scene, the testing apparatus and the tested vehicle 10 are placed at a first preset distance from each other in the test site, and the test site is a straight road without a block. In this embodiment, the first preset distance is 150 m. In this case, the tested vehicle 10 sends signals to the signal transceiver 4 and receives signals from the signal transceiver 4. The data analysis software in the upper computer 5 records a number of data packets corresponding to the first preset distance and calculates the packet loss rate. The tested vehicle 10 moves away from the testing apparatus and the packet loss rate is continuously calculated. When the upper computer 5 determines that the packet loss rate is 0%, the tested vehicle 10 moves away from the testing apparatus for 30 m; when the upper computer 5 determines that the packet loss rate is greater than 0% and less than 5%, the tested vehicle 10 moves away from the testing apparatus for 20 m. Each time adjusting the position of the tested vehicle 10, the tested vehicle receives and/or sends signals, the number of data packets corresponding to each communication distance is recorded, and the corresponding packet loss rate is calculated. Adjusting and testing end until the packet loss rate is greater than 5%. In this case, the distance between the front of the tested vehicle 10 and the testing apparatus is the maximum communication distance for the front of the vehicle.

Then, the tested vehicle 10 is turned, as shown in FIG. 4, such that the rear of the tested vehicle 10 is close to the testing apparatus. The maximum communication distance for the rear of the vehicle is tested following the above steps.

In some implementations, if the test scene is the straight road scene with a block, the step S500 includes the following steps:
S511: Place the testing apparatus and the tested vehicle at a second preset distance from each other in the test site, where a first block is disposed between the testing apparatus and the tested vehicle, and the test site is a straight road.
S512: The tested vehicle receives or sends signals, a number of data packets corresponding to the second preset distance is recorded, and a packet loss rate is calculated.
S513: When it is determined that the packet loss rate is 0%, increase a distance between the testing apparatus and the tested vehicle by 30 meters.
S514: When it is determined that the packet loss rate is greater than 0% and less than 5%, increase the distance between the testing apparatus and the tested vehicle by 20 meters.
S515: The tested vehicle receives or sends signals, a number of data packets corresponding to a current communication distance is recorded, and the corresponding packet loss rate is calculated.
S516: Repeat the steps S513 to S515 until the packet loss rate is greater than 5%, and take the current communication distance between the tested vehicle and the testing apparatus as the maximum communication distance.

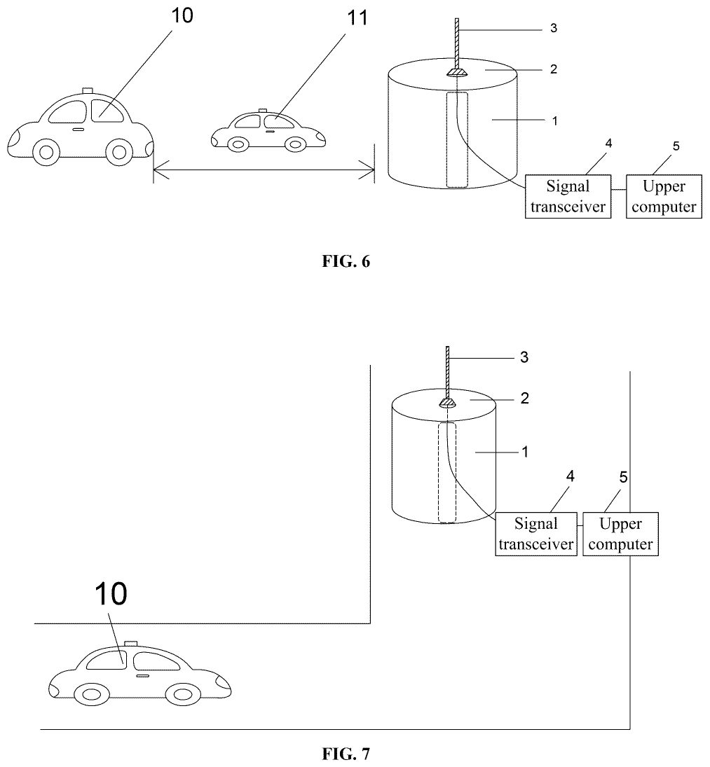

Specifically, FIG. 5 shows testing a maximum communication distance for the front of the vehicle in the straight road scene with a block; and FIG. 6 shows testing a maximum communication distance for the rear of the vehicle in the straight road scene with a block. The method for testing the maximum communication distance for the front of the vehicle is the same as that for testing the maximum communication distance for the rear of the vehicle, and testing the maximum communication distance for the front of the vehicle is used as an example below:

The testing apparatus and the tested vehicle 10 are placed at a second preset distance from each other in the test site. In this embodiment, the second preset distance is 150 m, and a first block 11 is disposed between the testing apparatus and the tested vehicle 10. In this embodiment, the first block 11 is a vehicle. In this case, the tested vehicle 10 sends signals to the signal transceiver 4 and receives signals from the signal transceiver 4. The data analysis software on the upper computer 5 records a number of data packets corresponding to the second preset distance and calculates the packet loss rate. The tested vehicle 10 moves away from the testing apparatus and the packet loss rate is continuously calculated. When the upper computer 5 determines that the packet loss rate is 0%, the tested vehicle 10 moves away from the testing apparatus for 30 m; when the upper computer 5 determines that the packet loss rate is greater than 0% and less than 5%, the tested vehicle 10 moves away from the testing apparatus for 20 m. Each time adjusting the position of the tested vehicle 10, the tested vehicle receives and/or sends signals, the number of data packets corresponding to each communication distance is recorded, and the corresponding packet loss rate is calculated. Adjusting and testing end until the packet loss rate is greater than 5%. In this case, the distance between the front of the tested vehicle 10 and the testing apparatus is the maximum communication distance for the front of the vehicle. Then, the tested vehicle 10 is turned, and the maximum communication distance for the rear of the vehicle is tested using the same method.

In some implementations, if the test scene is the intersection scene, the step S500 includes the following steps:
S521: Place the testing apparatus and the tested vehicle in the test site, where the test site is a crossroads, and the testing apparatus and the tested vehicle each are disposed at a third preset distance from a center of the crossroads.
S522: The tested vehicle receives or sends signals, a number of data packets corresponding to the third preset distance is recorded, and a packet loss rate is calculated.
S523: When it is determined that the packet loss rate is 0%, increase a distance between the testing apparatus and the tested vehicle by greater than 20 meters.
S524: When it is determined that the packet loss rate is greater than 0% and less than 5%, increase the distance between the testing apparatus and the tested vehicle by 20 meters.
S525: The tested vehicle receives or sends signals, a number of data packets corresponding to a current communication distance is recorded, and the corresponding packet loss rate is calculated.
S526: Repeat the steps S523 to S525 until the packet loss rate is greater than 5%, and take the current communication distance between the tested vehicle and the testing apparatus as the maximum communication distance.

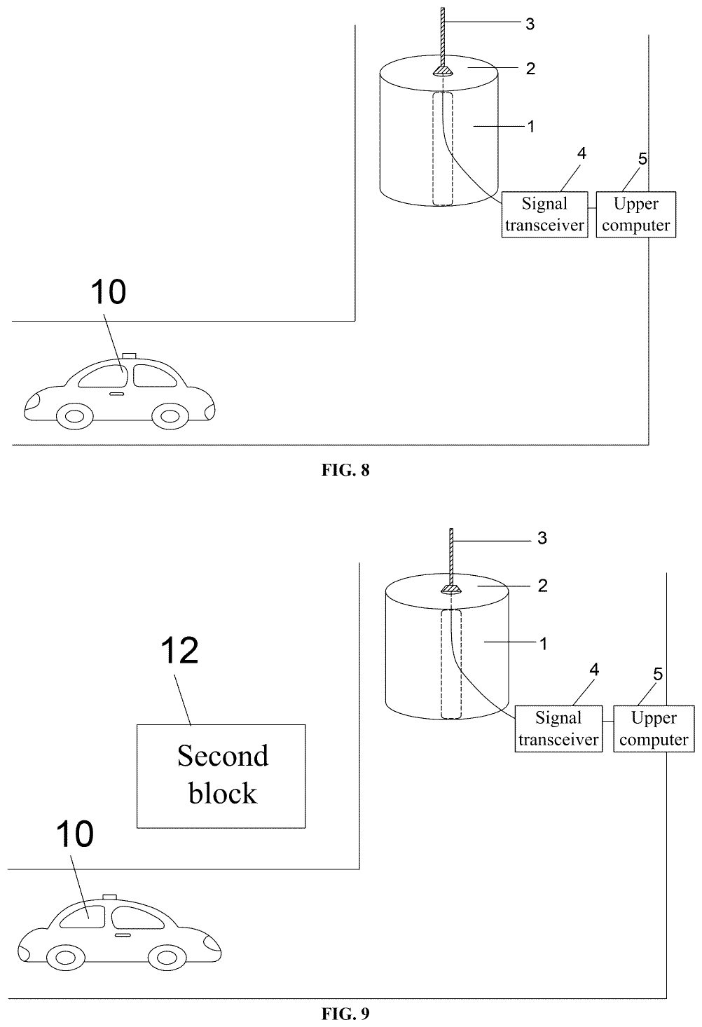

Specifically, FIG. 7 shows testing a maximum communication distance for the front of the vehicle in the intersection scene; and FIG. 8 shows testing a maximum communication distance for the rear of the vehicle in the intersection scene. The method for testing the maximum communication distance for the front of the vehicle is the same as that for testing the maximum communication distance for the rear of the vehicle, and testing the maximum communication distance for the front of the vehicle is used as an example below:

The testing apparatus and the tested vehicle 10 are placed in the test site. The test site is a crossroads without a block, and the testing apparatus and the tested vehicle 10 each are disposed at a third preset distance from a center of the crossroads. In this embodiment, the third preset distance is 80 m. In this case, the tested vehicle 10 sends signals to the signal transceiver 4 and receives signals from the signal transceiver 4. The data analysis software on the upper computer 5 records a number of data packets corresponding to the third preset distance and calculates the packet loss rate. The tested vehicle 10 moves away from the testing apparatus and the packet loss rate is continuously calculated. When the upper computer 5 determines that the packet loss rate is 0%, the tested vehicle 10 moves away from the testing apparatus for greater than 20 m; when the upper computer 5 determines that the packet loss rate is greater than 0% and less than 5%, the tested vehicle 10 moves away from the testing apparatus for 20 m. Each time adjusting the position of the tested vehicle 10, the tested vehicle receives and/or sends signals, the number of data packets corresponding to each communication distance is recorded, and the corresponding packet loss rate is calculated. Adjusting and testing end until the packet loss rate is greater than 5%. In this case, the distance between the front of the tested vehicle 10 and the testing apparatus is the maximum communication distance for the front of the vehicle. Then, the vehicle 10 is turned, and the maximum communication distance for the rear of the vehicle is tested using the same method.

In some implementations, if the test scene is the intersection scene with a block, the step S500 includes the following steps:
S531: Place the testing apparatus and the tested vehicle in the test site, where the test site is a crossroads, the testing apparatus and the tested vehicle each are disposed at a fourth preset distance from a center of the crossroads, and a second block is disposed at a side, of the tested vehicle, close to the testing apparatus.
S532: The tested vehicle receives and sends signals, a number of data packets corresponding to the fourth preset distance is recorded, and a packet loss rate is calculated.
S533: When it is determined that the packet loss rate is 0%, increase a distance between the testing apparatus and the tested vehicle by greater than 20 meters.
S534: When it is determined that the packet loss rate is greater than 0% and less than 5%, increase the distance between the testing apparatus and the tested vehicle by 20 meters.
S535: The tested vehicle receives or sends signals, a number of data packets corresponding to a current communication distance is recorded, and the corresponding packet loss rate is calculated.
S536: Repeat the steps S533 to S535 until the packet loss rate is greater than 5%, and take the current communication distance between the tested vehicle and the testing apparatus as the maximum communication distance.

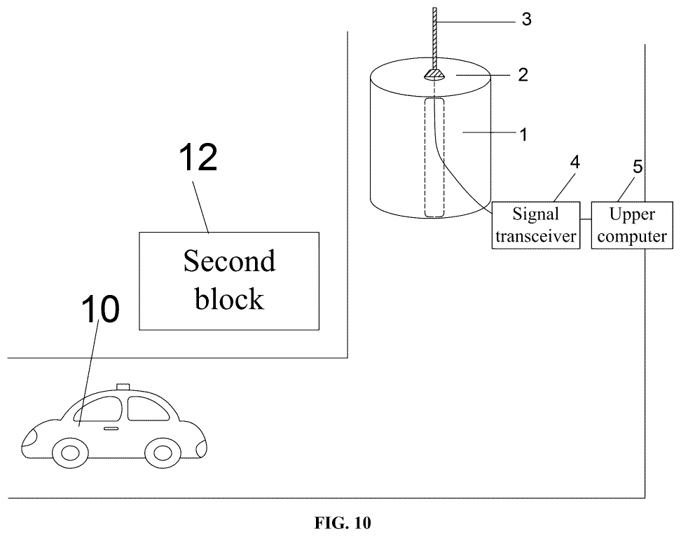

Specifically, FIG. 9 shows testing a maximum communication distance for the front of the vehicle in the intersection scene with a block; and FIG. 10 shows testing a maximum communication distance for the rear of the vehicle in the intersection scene with a block. The method for testing the maximum communication distance for the front of the vehicle is the same as that for testing the maximum communication distance for the rear of the vehicle, and testing the maximum communication distance for the front of the vehicle is used as an example below:

The testing apparatus and the tested vehicle 10 are placed in the test site. The test site is a crossroads, and the testing apparatus and the tested vehicle 10 each are placed at a fourth preset distance from a center of the crossroads. In this embodiment, the fourth preset distance is 80 m. A second block 12 is disposed at a side, of the tested vehicle, close to the testing apparatus. In this embodiment, the second block 12 is a building or a tree. In this case, the tested vehicle 10 sends signals to the signal transceiver 4 and receives signals from the signal transceiver 4. The data analysis software on the upper computer 5 records a number of data packets corresponding to the fourth preset distance and calculates the packet loss rate. The tested vehicle 10 moves away from the testing apparatus and the packet loss rate is continuously calculated. When the upper computer 5 determines that the packet loss rate is 0%, the tested vehicle 10 moves away from the testing apparatus for greater than 20 m; when the upper computer 5 determines that the packet loss rate is greater than 0% and less than 5%, the tested vehicle 10 moves away from the testing apparatus for 20 m. Each time adjusting the position of the tested vehicle 10, the tested vehicle receives and/or sends signals, the number of data packets corresponding to each communication distance is recorded, and the corresponding packet loss rate is calculated. Adjusting and testing end until the packet loss rate is greater than 5%. In this case, the distance between the front of the tested vehicle 10 and the testing apparatus is the maximum communication distance for the front of the vehicle. Then, the vehicle 10 is turned, and the maximum communication distance for the rear of the vehicle is tested using the same method.

The above description is merely an illustration of preferred embodiments of the present disclosure and the technical principle in use. Those skilled in the art should understand that, the scope of invention of the present disclosure is not limited to the technical solution formed by a specific combination of the foregoing technical features, but should cover other technical solutions formed by any combination of the foregoing technical features or equivalent features thereof without departing from the foregoing inventive concept. For example, a technical solution is formed by replacing the foregoing feature with a technical feature having a similar function disclosed in (but not limited to) the present disclosure.

What is claimed is:

1. An apparatus for testing a connected vehicle's communication distance, comprising:
a support member (1);
a first antenna (3) arranged on the support member (1);
a signal transceiver (4), wherein the signal transceiver (4) is connected to the first antenna (3) and is configured to send signals to a tested vehicle and/or receive signals sent by the tested vehicle;
an upper computer (5), wherein the upper computer (5) is connected to an output terminal of the signal transceiver (4), data analysis software is installed on the upper computer (5), and the data analysis software is used for recording a test distance and a number of data packets and calculating a packet loss rate.

2. The apparatus for testing a connected vehicle's communication distance according to claim 1, wherein an iron plate (2) is arranged at the top of the support member (1), and the first antenna (3) is arranged at the top of the iron plate (2), and the iron plate (2) is used for simulating a vehicle shell.

3. A method for testing a connected vehicle's communication distance, adopting the apparatus for testing a connected vehicle's communication distance according to claim 1, and comprising the following steps:
S100: selecting a test scene, and selecting a test site according to the test scene;
S200: according to the test scene, placing the testing apparatus in the test site, powering on the testing apparatus, and verifying that the testing apparatus works normally;
S300: placing a tested vehicle in the test site;
S400: performing interconnection debugging between the tested vehicle and the testing apparatus; and
S500: testing a maximum communication distance of the tested vehicle in receiving and/or sending modes in the test scene.

4. The method for testing a connected vehicle's communication distance according to claim 3, wherein before the step S100, performance of the testing apparatus is tested to confirm that a test result of the testing apparatus meets a communication requirement, and the test result comprises an antenna gain of the first antenna, and transmitting power and receiving sensitivity of the signal transceiver; specifically, the following steps are comprised:
S1: placing the testing apparatus on a turntable in a shielded chamber, and enabling a center of the testing apparatus to coincide with a center of the turntable;
S2: providing a test antenna at the top of the shielded chamber, and moving the test antenna in a circular motion centered on a center of the support member, to form a ¼ arc-shaped track;
S3: disconnecting the first antenna from the signal transceiver, connecting the first antenna to a second port of a network analyzer, and connecting the test antenna to a first port of the network analyzer;
S4: keeping a vertical angle of the test antenna unchanged, rotating the turntable in a horizontal direction, performing tests at different frequencies within a first angle range, and recording amplitudes and phases of near-field horizontal and vertical polarizations at each angle;
S5: keeping a horizontal angle of the first antenna unchanged, controlling the test antenna to move in a circular motion centered on the center of the support member, performing tests at different frequencies within a second angle range, and recording amplitudes and phases of near-field horizontal and vertical polarizations at each angle;
S6: performing, by using the network analyzer, near-field to far-field transformation on the amplitudes and phases of the near-field horizontal and vertical polarizations, to obtain the antenna gain of the first antenna; and
S7: connecting the signal transceiver to a broadband wireless communication tester, to measure the transmitting power and the receiving sensitivity of the signal transceiver.

5. The method for testing a connected vehicle's communication distance according to claim 3, wherein the test scene comprises a straight road scene, a straight road scene with a block, an intersection scene, and an intersection scene with a block.

6. The method for testing a connected vehicle's communication distance according to claim 5, wherein if the test scene is the straight road scene, the step S500 comprises the following steps:
S501: placing the testing apparatus and the tested vehicle at a first preset distance from each other in the test site, wherein the test site is a straight road;
S502: receiving or sending, by the tested vehicle, signals, recording a number of data packets corresponding to the first preset distance, and calculating a packet loss rate;
S503: when it is determined that the packet loss rate is 0%, increasing a distance between the testing apparatus and the tested vehicle by 30 meters;
S504: when it is determined that the packet loss rate is greater than 0% and less than 5%, increasing the distance between the testing apparatus and the tested vehicle by 20 meters;
S505: receiving or sending, by the tested vehicle, signals, recording a number of data packets corresponding to a current communication distance, and calculating the corresponding packet loss rate; and
S506: repeating the steps S503 to S505 until the packet loss rate is greater than 5%, and taking the current communication distance between the tested vehicle and the testing apparatus as the maximum communication distance.

7. The method for testing a connected vehicle's communication distance according to claim 5, wherein if the test scene is the straight road scene with a block, the step S500 comprises the following steps:
S511: placing the testing apparatus and the tested vehicle at a second preset distance from each other in the test site, wherein a first block is disposed between the testing apparatus and the tested vehicle, and the test site is a straight road;
S512: receiving or sending, by the tested vehicle, signals, recording a number of data packets corresponding to the second preset distance, and calculating a packet loss rate;
S513: when it is determined that the packet loss rate is 0%, increasing a distance between the testing apparatus and the tested vehicle by 30 meters;
S514: when it is determined that the packet loss rate is greater than 0% and less than 5%, increasing the distance between the testing apparatus and the tested vehicle by 20 meters;
S515: receiving or sending, by the tested vehicle, signals, recording a number of data packets corresponding to a current communication distance, and calculating the corresponding packet loss rate; and
S516: repeating the steps S513 to S515 until the packet loss rate is greater than 5%, and taking the current communication distance between the tested vehicle and the testing apparatus as the maximum communication distance.

8. The method for testing a connected vehicle's communication distance according to claim 5, wherein if the test scene is the intersection scene, the step S500 comprises the following steps:
S521: placing the testing apparatus and the tested vehicle in the test site, wherein the test site is a crossroads, and the testing apparatus and the tested vehicle each are disposed at a third preset distance from a center of the crossroads;
S522: receiving or sending, by the tested vehicle, signals, recording a number of data packets corresponding to the third preset distance, and calculating a packet loss rate;
S523: when it is determined that the packet loss rate is 0%, increasing a distance between the testing apparatus and the tested vehicle by greater than 20 meters;
S524: when it is determined that the packet loss rate is greater than 0% and less than 5%, increasing the distance between the testing apparatus and the tested vehicle by 20 meters;
S525: receiving or sending, by the tested vehicle, signals, recording a number of data packets corresponding to a current communication distance, and calculating the corresponding packet loss rate; and
S526: repeating the steps S523 to S525 until the packet loss rate is greater than 5%, and taking the current communication distance between the tested vehicle and the testing apparatus as the maximum communication distance.

9. The method for testing a connected vehicle's communication distance according to claim 5, wherein if the test scene is the intersection scene with a block, the step S500 comprises the following steps:
S531: placing the testing apparatus and the tested vehicle in the test site, wherein the test site is a crossroads, the testing apparatus and the tested vehicle each are disposed at a fourth preset distance from a center of the crossroads, and a second block is disposed at a side, of the tested vehicle, close to the testing apparatus;
S532: receiving or sending, by the tested vehicle, signals, recording a number of data packets corresponding to the fourth preset distance, and calculating a packet loss rate;
S533: when it is determined that the packet loss rate is 0%, increasing a distance between the testing apparatus and the tested vehicle by greater than 20 meters;
S534: when it is determined that the packet loss rate is greater than 0% and less than 5%, increasing the distance between the testing apparatus and the tested vehicle by 20 meters;
S535: receiving or sending, by the tested vehicle, signals, recording a number of data packets corresponding to a current communication distance, and calculating the corresponding packet loss rate; and
S536: repeating the steps S533 to S535 until the packet loss rate is greater than 5%, and taking the current communication distance between the tested vehicle and the testing apparatus as the maximum communication distance.

10. The method for testing a connected vehicle's communication distance according to claim 3, wherein an iron plate (2) is arranged at the top of the support member (1), and the first antenna (3) is arranged at the top of the iron plate (2), and the iron plate (2) is used for simulating a vehicle shell.
